(19) United States
(12) Patent Application Publication
(10) Pub. No.: US 2018/0356378 A1
(43) Pub. Date: Dec. 13, 2018

(54) METHOD FOR SELECTING A WORKING AREA OF A GAS CHROMATOGRAPHY COLUMN

(71) Applicant: Francois Ballet, Lyaud (FR)

(72) Inventor: Francois Ballet, Lyaud (FR)

(21) Appl. No.: 15/535,737

(22) PCT Filed: Dec. 21, 2015
(86) PCT No.: PCT/IB15/59818

§ 371 Date: Jun. 14, 2017

(30) Foreign Application Priority Data
Dec. 22, 2014 (FR) 14 63175

(51) Int. Cl. G01N 30/86; G01N 30/72; G01N 30/30; G01N 30/32; G01N 30/34

(52) U.S. Cl. CPC G01N 30/8693; G01N 30/7206; G01N 2030/025; G01N 30/32; G01N 30/34; G01N 30/30

(57) ABSTRACT

A method for selecting a working area of a gas chromatography column in order to use the column for analytical chromatography under predefined conditions of mobile phase composition, mobile phase flow rate and single linear thermal ramp control. The method includes a step during which a working area is selected in which the chromatography column follows a quasi-linear relationship between the retention time and the boiling point of the members of a homologous series.

### TECHNICAL FIELD OF THE INVENTION

The present invention relates to the field of gas chromatography, and relates more particularly to a method for selecting a working area of a gas chromatography column for using said column in analytical chromatography.

Gas chromatography is a physicochemical method for separating the species present in a sample in the gas phase.

Gas chromatography is performed using a capillary tube gas chromatography column. The sample containing one or more species to be identified is injected into the column by an injector, and is then entrained by a stream of mobile gas phase (most often helium, nitrogen or dihydrogen) in the column. The inside wall of the capillary tube is coated with a stationary phase. The stationary phase retains the species contained in the sample more or less strongly depending on the intensity of the forces of interaction between the different species and the stationary phase. The different species in the sample, entrained by the mobile phase, thus pass through the chromatography column along its entire length at different, characteristic velocities, so that they reach a detector (such as a mass spectrometer) provided at the outlet of the chromatography column at different times. The time specific to each species leaving the chromatography column is called the retention time.

The behavior of a chromatography column is a function of its geometry, the parameters of which are the inside diameter of the capillary tube, the length of the capillary tube and the thickness of stationary phase with which the inside wall of the capillary tube is coated.

In predetermined conditions of mobile phase composition, mobile phase flow rate and control of the column in a single linear temperature ramp, the retention time is characteristic of the species whose exit was detected. Thus, in so-called analytical chromatography with the aim of identifying the species contained in a sample, the retention times of the species to be identified are compared with the retention times of species already known, obtained in similar chromatography conditions, and then the identity of the species contained in the sample is identified therefrom.

As species that may serve as a standard, Kováts used paraffins (linear molecules of straight-chain saturated hydrocarbons, of formula CₙH₂ₙ₊₂) and attributed a retention index, equal to the number of carbon atoms multiplied by 100, to each of these paraffins. The paraffin C₁H₄ thus has a retention index of 100 whereas the paraffin C₂₅H₅₂ has a retention index of 2500.

Kováts modeled a linear variation of the retention times as a function of the number of carbon atoms in the paraffins. Using this model, when the retention time T_{R} of a species to be identified is bounded by the retention times T_{RA} and T_{RB} (with T_{RA}≤T_{R}≤T_{RB}) of any two paraffins A and B of retention index I_{A} and I_{B}, a gradient model is commonly applied, according to which a retention index I is attributed to the species to be identified, applying linear regression between the two paraffins A and B. The retention index I attributed to the species to be identified may then be calculated as follows:

I=I_{A}+K×(T_{R}−T_{RA}) with K=(I_{A}−I_{B})/(T_{RA}−T_{RB})

The retention index is then compared with retention indices in databases, such as that provided by NIST (National Institute of Scientific Technology), to identify the species.

When a new species is found, it is assigned a retention index by the same method, and it is then listed in the databases with its retention index.

Various documents refer to the Kovats linear model, notably:
document WO 97/01096 A1,
the scientific publication “Prediction of gas chromatographic retention indices as classifier in non-target analysis of environmental samples”, ULRICH Nadin et al., Journal of Chromatography, Elsevier Science Publishers B.V, Vol. 1285, 2013 Feb. 19,
the scientific publication “Determination of the boiling-point distribution by simulated distillation from n-pentane through n-tetratetracontane in 70 to 80 seconds”, LUBKOWITZ J. A. et al., Journal of Chromatographic Science, Vol. 40, 2002-05,
the scientific publication “Analysis of petroleum fractions by ASTM D2887”, MORGAN Peter et al., 2012,
standard ASTM D2287-01 “Standard test method for boiling range distribution of petroleum fractions by gas chromatography”, 2011-05.

However, the linear model used by Kováts is only an approximation. Even if this approximation is quite remarkable bearing in mind the equipment that was available to scientists at that time, when this model is used today, taking any paraffins whatever as reference, on any column, with chromatography devices whose accuracy has been improved considerably, the result is that one and the same species may be given various retention indices, which may vary greatly depending on the databases. This has an adverse effect on the reliability of analytical chromatography that is carried out with the aim of identifying the species of a sample.

### DESCRIPTION OF THE INVENTION

The present invention results from the applicant's observation that chromatography columns do not have a linear relation between the retention times and the retention indices of all the paraffins.

A problem proposed by the present invention is to make it possible to characterize a working area which is specific to each chromatography column and in which the Kováts linear model may be applied with a reasonable and satisfactory approximation.

To achieve these and other aims, the invention proposes a method for selecting a working area of a gas chromatography column for using said column in analytical chromatography in predetermined conditions of mobile phase composition, mobile phase flow rate and control in a single linear temperature ramp, said method comprising the following steps:

i) performing chromatography of several members of a homologous series on said column in said predetermined conditions in order to obtain the retention times of said members of the homologous series specific to said column,
ii) using tables containing the boiling points of the different members of the homologous series and using the retention times obtained in step i), establishing the data pair {retention time; boiling point} for each member of the homologous series,
iii) selecting a correlation coefficient (R) or coefficient of determination (R²) with a satisfactory estimated value,
iv) applying linear regression to groups of data pairs {retention time; boiling point} of consecutive members of the homologous series obtained in step ii),
v) selecting the group of data pairs {retention time; boiling point} of consecutive members of the homologous series displaying linearity with a correlation coefficient (R) or coefficient of determination (R²) with a value at least equal to the value of the coefficient of linear regression or coefficient of determination selected in step iii),
vi) selecting the working area corresponding to the time interval between the retention time of the member of the homologous series having the shortest carbon chain and the retention time of the member of the homologous series having the longest carbon chain of the group of data pairs {retention time; boiling point} selected in step v).

Thus, for each chromatography column, a working area is characterized in which, on applying the same predetermined conditions, it will be possible to apply the Kováts linear model while being subject to a low uncertainty of measurement, as a function of the correlation coefficient or coefficient of determination that it will be desirable to fix.

The invention results from the applicant's finding that there is a working area in which the chromatography column follows an almost linear relation between the retention time and the boiling point of the different members of a homologous series, and that it is therefore possible and judicious to make use of this property.

Advantageously, in steps i) and ii), we need only consider the members of the homologous series having a carbon chain of at least 5 carbon atoms. This avoids taking into account the small molecules that do not comply with the ideal gas laws and for which it is known that the exact law of boiling is not valid (as for paraffins, for example).

Preferably, in steps i) and ii), we need only consider the members of the homologous series having a carbon chain of at most 44 carbon atoms. The members of the homologous series comprising a carbon chain of more than 44 carbon atoms in fact come to the boil at very high temperatures, which require the use of very specific “high-temperature” chromatography columns. This also reduces the quality of chromatography considerably. Moreover, most of the molecules that we aim to identify by analytical chromatography have a retention index less than or equal to 4400 and therefore have a retention time less than or equal to that of the member of the homologous series having a carbon chain of at most 44 carbon atoms.

Preferably, in step i), chromatography of paraffins may be performed on said column. The paraffins in fact form a very simple homologous series in which the presence of an end group consisting of atoms different than the atoms constituting their carbon chain is avoided. Such an end group may in fact cause perturbations that will disrupt the existence of a linear relation between the boiling points and the retention times of the different members of the homologous series.

Advantageously, in step ii), the following table of boiling points of the different paraffins, to the nearest 0.5° C., is used:

| Number of carbon | | | |
|---|---|---|---|
| atoms present in | Retention | Paraffin | Boiling point |
| the paraffin | index | formula | (° C.) |
| Z = 1 | 100 | C₁H₄ | −161.0 |
| Z = 2 | 200 | C₂H₆ | −88.0 |
| Z = 3 | 300 | C₃H₈ | −42.0 |
| Z = 4 | 400 | C₄H₁₀ | −1.0 |
| Z = 5 | 500 | C₅H₁₂ | 36.0 |
| Z = 6 | 600 | C₆H₁₄ | 68.7 |
| Z = 7 | 700 | C₇H₁₆ | 98.4 |
| Z = 8 | 800 | C₈H₁₈ | 125.6 |
| Z = 9 | 900 | C₉H₂₀ | 150.8 |
| Z = 10 | 1000 | C₁₀H₂₂ | 174.1 |
| Z = 11 | 1100 | C₁₁H₂₄ | 195.9 |
| Z = 12 | 1200 | C₁₂H₂₆ | 216.3 |
| Z = 13 | 1300 | C₁₃H₂₈ | 235.4 |
| Z = 14 | 1400 | C₁₄H₃₀ | 253.5 |
| Z = 15 | 1500 | C₁₅H₃₂ | 270.6 |
| Z = 16 | 1600 | C₁₆H₃₄ | 286.5 |
| Z = 17 | 1700 | C₁₇H₃₆ | 301.7 |
| Z = 18 | 1800 | C₁₈H₃₈ | 316.1 |
| Z = 19 | 1900 | C₁₉H₄₀ | 329.7 |
| Z = 20 | 2000 | C₂₀H₄₂ | 342.6 |
| Z = 21 | 2100 | C₂₁H₄₄ | 355.0 |
| Z = 22 | 2200 | C₂₂H₄₆ | 366.8 |
| Z = 23 | 2300 | C₂₃H₄₈ | 378.3 |
| Z = 24 | 2400 | C₂₄H₅₀ | 389.5 |
| Z = 25 | 2500 | C₂₅H₅₂ | 400.5 |
| Z = 26 | 2600 | C₂₆H₅₄ | 411.2 |
| Z = 27 | 2700 | C₂₇H₅₆ | 421.5 |
| Z = 28 | 2800 | C₂₈H₅₈ | 431.6 |
| Z = 29 | 2900 | C₂₉H₆₀ | 440.8 |
| Z = 30 | 3000 | C₃₀H₆₂ | 449.7 |

Advantageously, in step iii), a coefficient of linear regression or coefficient of determination is selected having a value greater than or equal to about 0.9. Such a coefficient makes it possible to select a working area in which it will be possible to apply the Kováts linear model satisfactorily.

According to another aspect of the invention, a method is proposed for analytical gas chromatography of a substance in the gas phase carried out in a chromatography column;
according to the invention, said method of analytical gas chromatography comprises the following steps:
   a) selecting a working area using the method of selection described above,
   b) performing chromatography of the substance to be analyzed in the column used in step a) and according to the predetermined conditions of mobile phase flow rate and control in a linear temperature ramp used in step a), detecting the retention times of the different species present in the substance analyzed,
   c) only keeping the retention times of the different species present in the substance analyzed comprised in the working area,
   d) attributing a retention index to each species present in the substance analyzed, using the retention times of the members of the homologous series determined in step i) and their retention indices.

Confining analytical chromatography to the working area selected in step a) ensures being able to apply the Kováts linear model satisfactorily.

Preferably, in step d), linear regression is performed between:
the retention index of the member of the homologous series having a retention time that is just less than the retention time of said species,
the retention index of the member of the homologous series having a retention time that is just above the retention time of said species.

By only performing linear regression, it is possible to gain considerable calculation time, while maintaining satisfactory accuracy for the index that will be determined for the species to be identified.

Moreover, performing linear regression with the retention indices of the members of the homologous series having retention times that are just adjacent makes it possible to limit to the maximum the so-called “chord effect” which occurs mathematically when linear regression is applied for a point on the ordinate to be determined and that is located between two points which are in reality located on a curve at least of the second degree (and not a straight line) as is the case for the paraffins in particular.

Advantageously, step b) may be carried out simultaneously with step i). Thus, selection of the working area and analytical chromatography are performed simultaneously. The conditions applied to the column for analytical chromatography are thus strictly the same as those applied for selecting the working area. The accuracy of measurement is thus increased, making the operating parameters of the chromatography column unimportant to the maximum extent.

### BRIEF DESCRIPTION OF THE DRAWINGS

Other aims, features and advantages of the present invention will become clear from the following description of particular embodiments, made in relation to the appended figures, where:

FIG. 1 is a graph illustrating, for the paraffins having a carbon chain with from 2 to 30 carbon atoms, the relation that exists between the retention index and the retention time;

FIG. 2 is a graph illustrating, for the paraffins having a carbon chain with from 2 to 30 carbon atoms, the relation that exists between the retention time and the boiling point of said paraffins;

FIG. 3 is a selection of a working area of the graph in FIG. 1; and

FIG. 4 is a graph illustrating the use of the working area selected in FIG. 3 for performing analytical gas chromatography.

### DESCRIPTION OF THE PREFERRED EMBODIMENTS

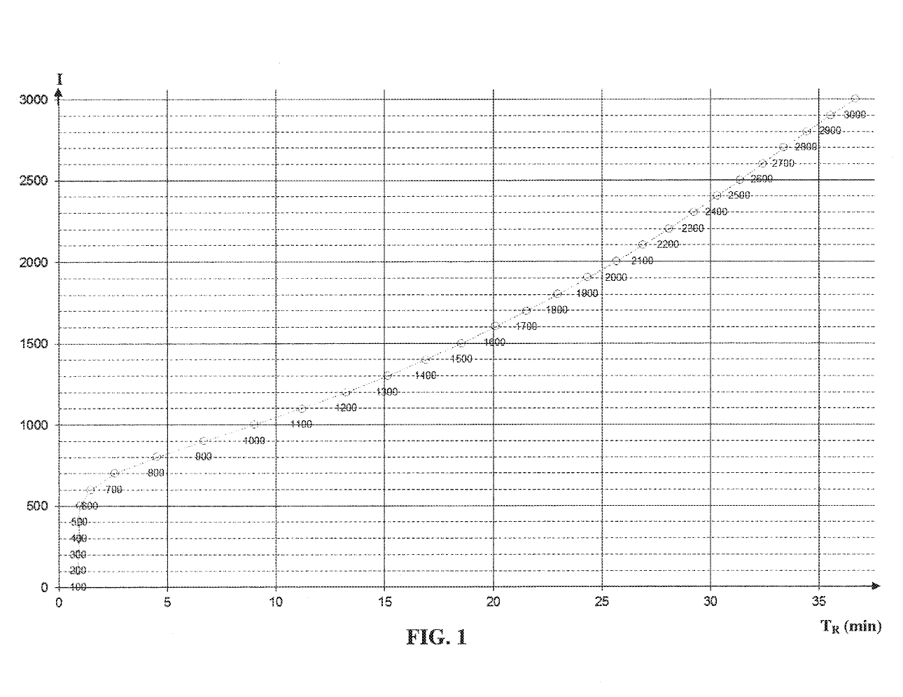

FIGS. 1 to 3 are graphs illustrating the method for selecting a working area according to the invention, applied to a chromatography column in predetermined conditions of mobile phase composition, mobile phase flow rate and control in a single linear temperature ramp. Although the method is applied here with the homologous series of the paraffins for greater rigor and precision, the present invention is also applicable with any other homologous series, such as the homologous series of the alcohols, for example.

Gas chromatography of paraffins is carried out in a step i). In the case illustrated in FIGS. 1 to 3, a single linear temperature ramp with an initial temperature of 44° C. is applied to the chromatography column. After holding at 44° C. for 2 minutes, a temperature rise of 8° C. per minute was applied until 300° C. was reached.

The chromatography column is a DB1 capillary column marketed by the company AGILENT Technologies, Inc. Said chromatography column comprises a stationary phase constituted to 100% of dimethylpolysiloxane with a thickness of 0.5 μm grafted onto the inside wall of a capillary tube with a length of 30 meters and an inside diameter of 0.32 mm.

The retention times were recorded for the different paraffins having a number of carbon atoms between 2 and 30, which gives the following table of values:

| Number of carbon | | | |
|---|---|---|---|
| atoms present in | Retention | Paraffin | Retention time |
| the paraffin | index | formula | (min) |
| Z = 2 | 200 | C₂H₆ | 0.90 |
| Z = 3 | 300 | C₃H₈ | 0.92 |
| Z = 4 | 400 | C₄H₁₀ | 0.94 |
| Z = 5 | 500 | C₅H₁₂ | 0.97 |
| Z = 6 | 600 | C₆H₁₄ | 1.46 |
| Z = 7 | 700 | C₇H₁₆ | 2.58 |
| Z = 8 | 800 | C₈H₁₈ | 4.50 |
| Z = 9 | 900 | C₉H₂₀ | 6.70 |
| Z = 10 | 1000 | C₁₀H₂₂ | 9.02 |
| Z = 11 | 1100 | C₁₁H₂₄ | 11.20 |
| Z = 12 | 1200 | C₁₂H₂₆ | 13.24 |
| Z = 13 | 1300 | C₁₃H₂₈ | 15.14 |
| Z = 14 | 1400 | C₁₄H₃₀ | 16.92 |
| Z = 15 | 1500 | C₁₅H₃₂ | 18.56 |
| Z = 16 | 1600 | C₁₆H₃₄ | 20.10 |
| Z = 17 | 1700 | C₁₇H₃₆ | 21.56 |
| Z = 18 | 1800 | C₁₈H₃₈ | 22.96 |
| Z = 19 | 1900 | C₁₉H₄₀ | 24.35 |
| Z = 20 | 2000 | C₂₀H₄₂ | 25.68 |
| Z = 21 | 2100 | C₂₁H₄₄ | 26.90 |
| Z = 22 | 2200 | C₂₂H₄₆ | 28.08 |
| Z = 23 | 2300 | C₂₃H₄₈ | 29.22 |
| Z = 24 | 2400 | C₂₄H₅₀ | 30.31 |
| Z = 25 | 2500 | C₂₅H₅₂ | 31.37 |
| Z = 26 | 2600 | C₂₆H₅₄ | 32.40 |
| Z = 27 | 2700 | C₂₇H₅₆ | 33.39 |
| Z = 28 | 2800 | C₂₈H₅₈ | 34.45 |
| Z = 29 | 2900 | C₂₉H₆₀ | 35.54 |
| Z = 30 | 3000 | C₃₀H₆₂ | 36.69 |

The graph in FIG. 1 presents these data, showing the retention time T_{R} of the paraffins as a function of their retention index I. It can be seen that it is indeed a curve and not a straight line.

In a subsequent step ii), its boiling point is assigned to each paraffin (and therefore to each paraffin retention index). For this we may make use of tables from the scientific literature, such as that supplied by NIST (National Institute of Scientific Technology).

In the present case, the following table is used, regarded as reliable by the applicant:

| Number of carbon | | | |
|---|---|---|---|
| atoms present in | Retention | Paraffin | Boiling point |
| the paraffin | index | formula | (° C.) |
| Z = 1 | 100 | C₁H₄ | −161.0 |
| Z = 2 | 200 | C₂H₆ | −88.0 |
| Z = 3 | 300 | C₃H₈ | −42.0 |
| Z = 4 | 400 | C₄H₁₀ | −1.0 |
| Z = 5 | 500 | C₅H₁₂ | 36.0 |
| Z = 6 | 600 | C₆H₁₄ | 68.7 |
| Z = 7 | 700 | C₇H₁₆ | 98.4 |
| Z = 8 | 800 | C₈H₁₈ | 125.6 |
| Z = 9 | 900 | C₉H₂₀ | 150.8 |
| Z = 10 | 1000 | C₁₀H₂₂ | 174.1 |
| Z = 11 | 1100 | C₁₁H₂₄ | 195.9 |
| Z = 12 | 1200 | C₁₂H₂₆ | 216.3 |
| Z = 13 | 1300 | C₁₃H₂₈ | 235.4 |
| Z = 14 | 1400 | C₁₄H₃₀ | 253.5 |
| Z = 15 | 1500 | C₁₅H₃₂ | 270.6 |
| Z = 16 | 1600 | C₁₆H₃₄ | 286.5 |
| Z = 17 | 1700 | C₁₇H₃₆ | 301.7 |
| Z = 18 | 1800 | C₁₈H₃₈ | 316.1 |
| Z = 19 | 1900 | C₁₉H₄₀ | 329.7 |
| Z = 20 | 2000 | C₂₀H₄₂ | 342.6 |
| Z = 21 | 2100 | C₂₁H₄₄ | 355.0 |
| Z = 22 | 2200 | C₂₂H₄₆ | 366.8 |
| Z = 23 | 2300 | C₂₃H₄₈ | 378.3 |
| Z = 24 | 2400 | C₂₄H₅₀ | 389.5 |
| Z = 25 | 2500 | C₂₅H₅₂ | 400.5 |
| Z = 26 | 2600 | C₂₆H₅₄ | 411.2 |
| Z = 27 | 2700 | C₂₇H₅₆ | 421.5 |
| Z = 28 | 2800 | C₂₈H₅₈ | 431.6 |
| Z = 29 | 2900 | C₂₉H₆₀ | 440.8 |
| Z = 30 | 3000 | C₃₀H₆₂ | 449.7 |

We thus obtain the following table, relating the data pair {retention time; boiling point} for each paraffin identified during chromatography:

| Number of | | | | |
|---|---|---|---|---|
| carbon atoms | | | Retention | Boiling |
| present in the | Retention | Paraffin | time T_{R} | point T_{B} |
| paraffin | index | formula | (min) | (° C.) |
| Z = 2 | 200 | C₂H₆ | 0.90 | −88.0 |
| Z = 3 | 300 | C₃H₈ | 0.92 | −42.0 |
| Z = 4 | 400 | C₄H₁₀ | 0.94 | −1.0 |
| Z = 5 | 500 | C₅H₁₂ | 0.97 | 36.0 |
| Z = 6 | 600 | C₆H₁₄ | 1.46 | 68.7 |
| Z = 7 | 700 | C₇H₁₆ | 2.58 | 98.4 |
| Z = 8 | 800 | C₈H₁₈ | 4.50 | 125.6 |
| Z = 9 | 900 | C₉H₂₀ | 6.70 | 150.8 |
| Z = 10 | 1000 | C₁₀H₂₂ | 9.02 | 174.1 |
| Z = 11 | 1100 | C₁₁H₂₄ | 11.20 | 195.9 |
| Z = 12 | 1200 | C₁₂H₂₆ | 13.24 | 216.3 |
| Z = 13 | 1300 | C₁₃H₂₈ | 15.14 | 235.4 |
| Z = 14 | 1400 | C₁₄H₃₀ | 16.92 | 253.5 |
| Z = 15 | 1500 | C₁₅H₃₂ | 18.56 | 270.6 |
| Z = 16 | 1600 | C₁₆H₃₄ | 20.10 | 286.5 |
| Z = 17 | 1700 | C₁₇H₃₆ | 21.56 | 301.7 |
| Z = 18 | 1800 | C₁₈H₃₈ | 22.96 | 316.1 |
| Z = 19 | 1900 | C₁₉H₄₀ | 24.35 | 329.7 |
| Z = 20 | 2000 | C₂₀H₄₂ | 25.68 | 342.6 |
| Z = 21 | 2100 | C₂₁H₄₄ | 26.90 | 355.0 |
| Z = 22 | 2200 | C₂₂H₄₆ | 28.08 | 366.8 |
| Z = 23 | 2300 | C₂₃H₄₈ | 29.22 | 378.3 |
| Z = 24 | 2400 | C₂₄H₅₀ | 30.31 | 389.5 |
| Z = 25 | 2500 | C₂₅H₅₂ | 31.37 | 400.5 |
| Z = 26 | 2600 | C₂₆H₅₄ | 32.40 | 411.2 |
| Z = 27 | 2700 | C₂₇H₅₆ | 33.39 | 421.5 |
| Z = 28 | 2800 | C₂₈H₅₈ | 34.45 | 431.6 |
| Z = 29 | 2900 | C₂₉H₆₀ | 35.54 | 440.8 |
| Z = 30 | 3000 | C₃₀H₆₂ | 36.69 | 449.7 |

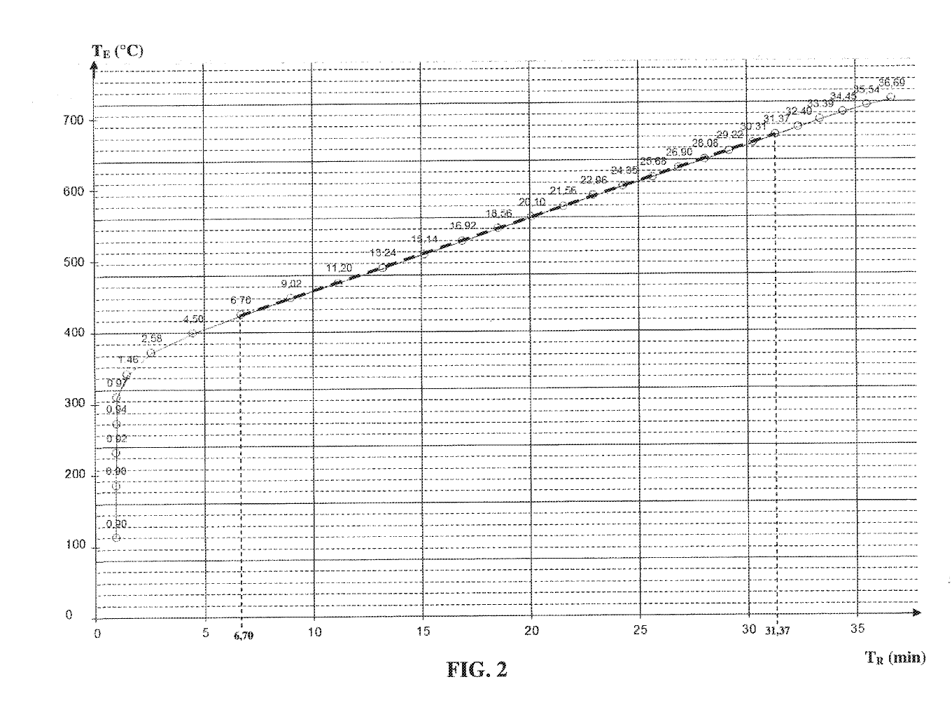

The graph in FIG. 2 presents these data, showing the boiling point as a function of the retention time of the paraffins. It can be seen that it is a curve having a roughly linear section between the retention time of the paraffin having 7 carbon atoms and the retention time of the paraffin having 27 carbon atoms.

A coefficient of determination R² with a satisfactory estimated value is then fixed, and linear regression is then applied to groups of data pairs (retention time; boiling point) of consecutive paraffins obtained previously.

In the case illustrated in FIG. 2, a coefficient of determination R² is selected that is greater than or equal to 0.99999. We then determine that the boiling point T_{g} of the paraffins having between 9 and 25 carbon atoms obeys the following equation:

T_{E}=10.13151×T_{R}+82.57625

We were thus able to determine that, for the column used in the conditions applied of mobile phase composition, mobile phase flow rate and control in a single linear temperature ramp, there is an almost perfectly linear relation between the boiling point and the retention time of the paraffins having from 9 to 25 carbon atoms, moreover with a coefficient of determination R² greater than or equal to 0.99999.

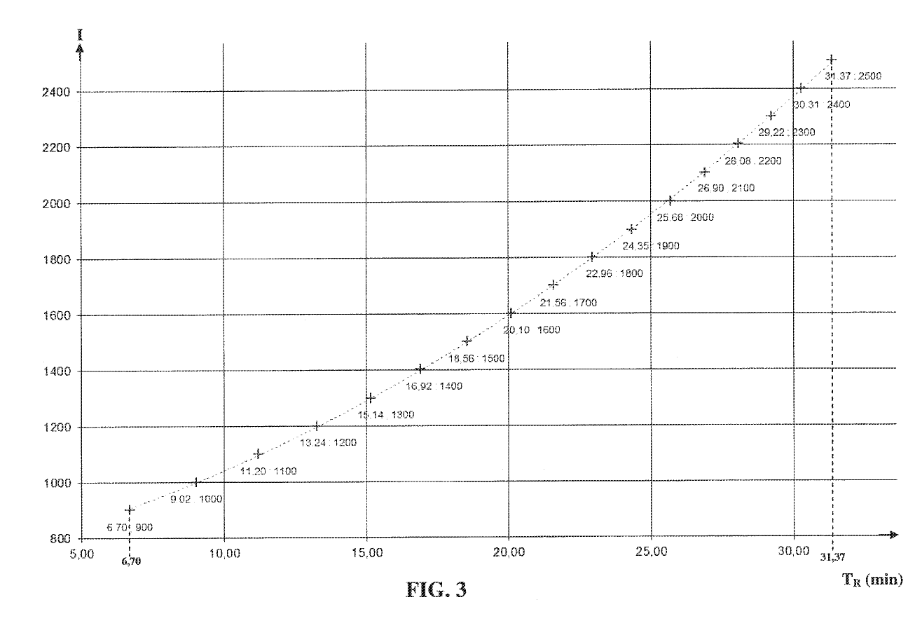

Then the time interval between the retention time of the paraffin having 9 carbon atoms and the retention time of the paraffin having 25 carbon atoms is selected as the working area, in the graph in FIG. 1. In this working area, it will be possible to apply the Kováts linear model while being subject to a low uncertainty of measurement, a function of the correlation coefficient or coefficient of determination that has been fixed. This working area is illustrated in more detail in FIG. 3.

During gas chromatography using the same column, used in the same predetermined conditions of mobile phase composition, mobile phase flow rate and control in a single linear temperature ramp, the retention times of the different species present in the substance analyzed are recorded. This analytical chromatography may be carried out simultaneously with selection of the working area or after selection of the working area.

During this chromatography, only the retention times of the different species present in the substance analyzed comprised in the working area are retained. In the present case, only the retention times between 6.70 minutes and 31.37 minutes are retained here.

For example, we may record a retention time T_{R} of 25 minutes for a species to be determined. As this retention time is between 6.70 minutes and 31.37 minutes, it is located in the working area and is therefore kept.

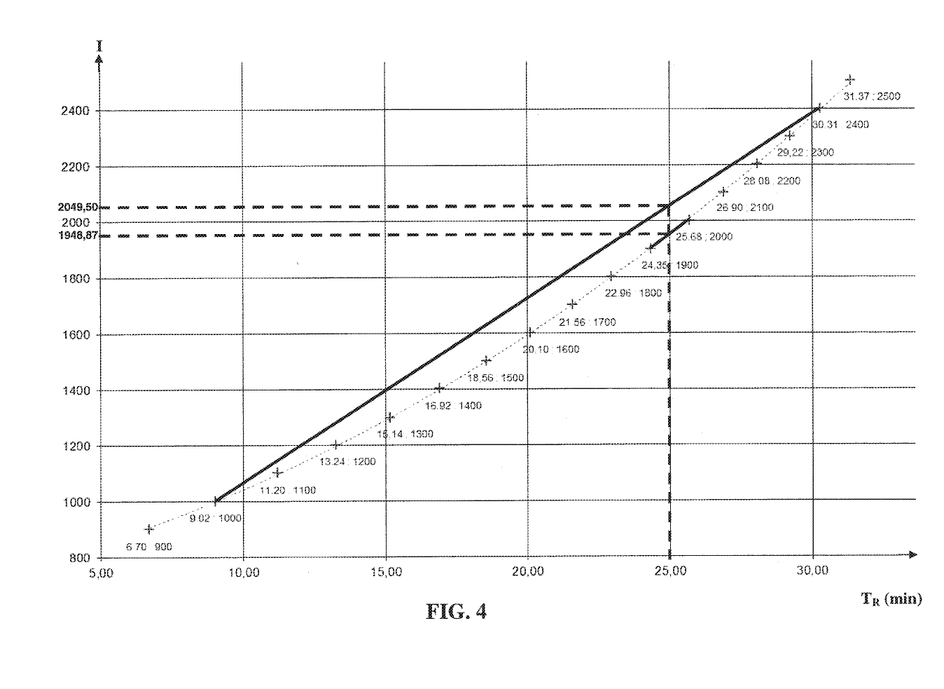

The retention time of the species to be identified is between the paraffins having 19 and 20 carbon atoms respectively. It is then attributed a retention index I based on the retention indices I₁₉ and I₂₀, and the following calculation (illustrated graphically in FIG. 4) is performed on the retention times T₁₉ and T₂₀ of these two adjacent paraffins only:

I=I₁₉+K×(T_{R}−T₁₉) with K=(I₁₉−I₂₀)/(T₁₉−T₂₀)

We thus arrive at a retention index I of 1948.87.

This index is then compared with the available databases to find the molecule to which the species identified could correspond.

By using the retention indices and retention times of the paraffins immediately adjacent, it is possible to maintain a maximum of precision to limit a “chord effect” that would distort the determination of the retention index of the species to be determined.

Such a chord effect is illustrated for example in FIG. 4, where the retention index I of the species to be determined was also calculated from the retention times and retention indices of the paraffins having 10 and 24 carbon atoms respectively. We then get:

I=I₁₀+K×(T_{R}−T₁₀) with K=(I₁₀−I₂₄)/(T₁₀−T₂₄)=2049.50

The retention index I is thus falsified by a little more than 100 points, which is of course very detrimental as this greatly compromises the chances of properly identifying the molecule corresponding to the species to be identified using the table of data on retention indices.

The low level of uncertainty of the method of analytical gas chromatography according to the invention can be illustrated by calculating the mathematical equation of the curve on which the points of the graph in FIGS. 3 and 4 are located. In this case, the curve formed by these points can be approximated, with a coefficient of determination of 0.99989, by the following quadratic equation:

I=1.12509×T_{R2}+21.33930×T_{R}+715.63113

Applying this equation with a retention time T_{R} of 25 minutes, we find a retention index I of 1952.29, which is clearly very close to the retention index I of 1948.87 found previously.

The method of analytical gas chromatography according to the invention therefore makes it possible for the practitioner to avoid carrying out long and laborious calculations of quadratic equations, while maintaining satisfactory precision in the calculation of the retention index I of the species to be identified.

The present invention is not limited to the embodiments that have been described explicitly, but includes the different variants and generalizations that are within the scope of the claims hereunder.

1. A method for selecting a working area of a gas chromatography column for using said column in analytical chromatography in predetermined conditions of mobile phase composition, mobile phase flow rate and control in a single linear temperature ramp, comprising the following steps:
i) performing chromatography of several members of a homologous series on said column in said predetermined conditions in order to obtain the retention times of said members of the homologous series specific to said column,
ii) using tables containing the boiling points of the different members of the homologous series and using the retention times obtained in step i), establishing the data pair (retention time; boiling point) for each member of the homologous series,
iii) selecting a correlation coefficient (R) or coefficient of determination (R²) with a satisfactory estimated value,
iv) applying linear regression to groups of data pairs (retention time; boiling point) of consecutive members of the homologous series obtained in step ii),
v) selecting the group of data pairs (retention time; boiling point) of consecutive members of the homologous series displaying linearity with a correlation coefficient (R) or coefficient of determination (R²) with a value at least equal to the value of the coefficient of linear regression or coefficient of determination selected in step iii),
vi) selecting the working area corresponding to the time interval between the retention time of the member of the homologous series having the shortest carbon chain and the retention time of the member of the homologous series having the longest carbon chain of the group of data pairs (retention time; boiling point) selected in step v).

2. The method of selection as claimed in claim 1, wherein, in steps i) and ii), only the members of the homologous series having a carbon chain of at least 5 carbon atoms are considered.

3. The method of selection as claimed in claim 1, wherein, in steps i) and ii), only the members of the homologous series having a carbon chain of at most 44 carbon atoms are considered.

4. The method of selection as claimed in claim 1, wherein, in step i), chromatography of paraffins is carried out on said column.

5. The method of selection as claimed in claim 4, wherein, in step ii), the following table of boiling points of the different paraffins, to the nearest 0.5° C., is used:

| Number of carbon | | | |
|---|---|---|---|
| atoms present in | Retention | Paraffin | Boiling point |
| the paraffin | index | formula | (° C.) |
| Z = 1 | 100 | C₁H₄ | −161.0 |
| Z = 2 | 200 | C₂H₆ | −88.0 |
| Z = 3 | 300 | C₃H₈ | −42.0 |
| Z = 4 | 400 | C₄H₁₀ | −1.0 |
| Z = 5 | 500 | C₅H₁₂ | 36.0 |
| Z = 6 | 600 | C₆H₁₄ | 68.7 |
| Z = 7 | 700 | C₇H₁₆ | 98.4 |
| Z = 8 | 800 | C₈H₁₈ | 125.6 |
| Z = 9 | 900 | C₉H₂₀ | 150.8 |
| Z = 10 | 1000 | C₁₀H₂₂ | 174.1 |
| Z = 11 | 1100 | C₁₁H₂₄ | 195.9 |
| Z = 12 | 1200 | C₁₂H₂₆ | 216.3 |
| Z = 13 | 1300 | C₁₃H₂₈ | 235.4 |
| Z = 14 | 1400 | C₁₄H₃₀ | 253.5 |
| Z = 15 | 1500 | C₁₅H₃₂ | 270.6 |
| Z = 16 | 1600 | C₁₆H₃₄ | 286.5 |
| Z = 17 | 1700 | C₁₇H₃₆ | 301.7 |
| Z = 18 | 1800 | C₁₈H₃₈ | 316.1 |
| Z = 19 | 1900 | C₁₉H₄₀ | 329.7 |
| Z = 20 | 2000 | C₂₀H₄₂ | 342.6 |
| Z = 21 | 2100 | C₂₁H₄₄ | 355.0 |
| Z = 22 | 2200 | C₂₂H₄₆ | 366.8 |
| Z = 23 | 2300 | C₂₃H₄₈ | 378.3 |
| Z = 24 | 2400 | C₂₄H₅₀ | 389.5 |
| Z = 25 | 2500 | C₂₅H₅₂ | 400.5 |
| Z = 26 | 2600 | C₂₆H₅₄ | 411.2 |
| Z = 27 | 2700 | C₂₇H₅₆ | 421.5 |
| Z = 28 | 2800 | C₂₈H₅₈ | 431.6 |
| Z = 29 | 2900 | C₂₉H₆₀ | 440.8 |
| Z = 30 | 3000 | C₃₀H₆₂ | 449.7 |

6. The method of selection as claimed in claim 1, wherein, in step iii), a coefficient of linear regression or coefficient of determination is selected having a value greater than or equal to about 0.9.

7. A method of analytical gas chromatography of a substance in the gas phase, carried out in a chromatography column, comprising the following steps:
a) selecting a working area using the method of selection as claimed in claim 1,
b) performing chromatography of the substance to be analyzed in the column used in step a) and according to the predetermined conditions of mobile phase flow rate and control in a linear temperature ramp used in step a), detecting the retention times of the different species present in the substance analyzed,
c) only keeping the retention times of the different species present in the substance analyzed comprised in the working area,
d) attributing a retention index to each species present in the substance analyzed, using the retention times of the members of the homologous series determined in step I) and their retention Indices.

8. The method of analytical gas chromatography as claimed in claim 7, wherein, in step d), linear regression is performed between:
the retention index of the member of the homologous series having a retention time that is just less than the retention time of said species,
the retention index of the member of the homologous series having a retention time that is just above the retention time of said species.

9. The method of analytical gas chromatography as claimed in claim 7, wherein step b) is carried out simultaneously with step I).
